(19) United States
(12) Patent Application Publication
(10) Pub. No.: US 2010/0207058 A1
(43) Pub. Date: Aug. 19, 2010

(54) POLISHING COMPOSITION

(76) Inventors: Yoshiyuki Matsumura, Kyoto (JP); Hiroshi Nitta, Kyoto (JP)

Correspondence Address: HARNESS, DICKEY & PIERCE, P.L.C., P.O. BOX 8910, RESTON, VA, 20195, US

(21) Appl. No.: 12/733,328

(22) PCT Filed: Aug. 25, 2008
(86) PCT No.: PCT/JP2008/065131

§ 371 Date: Feb. 24, 2010

(30) Foreign Application Priority Data
Aug. 24, 2007 (JP) 2007-218985

(51) Int. Cl. C09K 13/00

(52) U.S. Cl. 252/79.1

(57) ABSTRACT

At least one embodiment of the invention provides a polishing composition that can achieve high polishing rate and as well can improve flatness. The polishing composition of at least one embodiment of the invention is a polishing composition suitable for a metal film, particularly a copper (Cu) film, and contains a basic compound containing an ammonium group, alkyl naphthalene sulfonate and hydrogen peroxide, the remainder being water. The pH of the polishing composition is within a range of 8 to 12. By containing those, a polishing composition that can achieve high polishing rate and improve flatness can be realized.

### TECHNICAL FIELD

The present invention relates to a polishing composition for polishing a metal film, in particular, for polishing a copper film.

### BACKGROUND ART

To meet demands for high integration and reduction in size of semiconductor integrated circuits (LSIs), a technique called system in package (SIP) in which a plurality of semiconductors having various functions such as memory function and logic function are three-dimensionally mounted on one substrate has been developed. With this technique, numbers of wirings and bumps, formed on the substrate are increased, and diameters of wirings are decreased. As a result, formation of fine wirings becomes difficult in conventional build-up methods and mechanical polishing.

For this reason, copper, copper alloy and the like having electric resistance lower than that of aluminum are utilized in place of aluminum conventionally used as a wiring material. However, due to the properties of copper, copper is difficult to form wiring by dry etching as in aluminum, and for this reason, a wiring formation method called a damascene process is established.

According to a damascene process used in a semiconductor process, for example, wirings and plugs are formed on the surface of a substrate by forming grooves corresponding to wiring patterns to be formed and holes corresponding to plugs (electrically connecting portions to wirings in the inside of a substrate) to be formed on the surface of a substrate coated with a silicon dioxide film, forming a barrier metal film (insulating film) comprising titanium, titanium nitride, tantalum, tantalum nitride, tungsten or the like on an inner wall surface of the grooves and holes, coating the whole surface of the substrate with a copper film by plating or the like to embed copper in the grooves and holes, and removing excess copper film on a region other than the grooves and holes by chemical mechanical polishing (CMP).

The damascene process and CMP can be applied to SIP in a similar manner. However, because a thickness of a metal film such as a copper film coated on the surface of a substrate ranges 5 μm or more, there are concerns regarding increase in processing time by CMP and great deterioration of productivity.

It is considered in CMP to a metal layer that polishing proceeds by a process that compounds formed on the surface of a metal by chemical reaction in an acidic region are polished by polishing abrasive grains. From this, slurry used in CMP to a metal layer is generally acidic.

However, acidic slurry has the tendency that polishing rate is decreased as the number of layers to be polished is increased. Furthermore, when an alkaline washing liquid for removing abrasive grains is used after polishing, abrasive grains become massed together by pH shock. For this reason, alkaline slurry enabling high speed polishing is desired in place of acidic slurry.

A polishing composition for CMP containing polishing abrasive grains, ammonium persulfate, oxalic acid, benzotriazol, dodecylbenzene sulfonic acid and/or a salt of dodecylbenzene sulfonic acid, polyvinyl pyrrolidone, and a pH regulator that is a water-soluble basic compound is disclosed as slurry used in alkaline state at a pH of from 8 to 12 (see Japanese Unexamined Patent Publication JP-A 2007-13059).

It is disclosed that a polishing composition having sufficient copper polishing rate and large difference of polishing rate to a barrier layer can be realized by such a constitution.

It is described that the polishing composition described in JP-A 2007-13059 has sufficient copper polishing rate. However, as described in Examples 1 to 3, copper polishing rate is in a range of about 0.210 to 0.260 μm, and is less than 1 μm/min. Furthermore, Comparative Example 4 uses hydrogen peroxide, but polishing rate is not improved at all.

Thus, in the conventional polishing composition, sufficient copper polishing rate is not yet obtained, and flatness is not improved. For this reason, a polishing composition that can achieve higher polishing rate and can improve flatness is desired.

Furthermore, the state that the surface of a substrate is dipped in the polishing composition occurs during non-polishing such as before and after polishing treatment. Where etching force of the polishing composition is large, a metal layer is etched during non-polishing, and flatness may be deteriorated.

### DISCLOSURE OF INVENTION

An object of the invention is to provide a polishing composition that can achieve high polishing rate and as well can improve flatness.

The invention provides a polishing composition comprising a basic compound containing an ammonium group, alkyl naphthalene sulfonate and hydrogen peroxide.

In the invention, it is preferable that the polishing composition has a pH of from 8 to 12.

In the invention, it is preferable that the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

In the invention, it is preferable that a content of the alkyl naphthalene sulfonate is from 0.15 to 0.5% by weight of a total amount of the polishing composition.

In the invention, it is preferable that the polishing composition comprises abrasive grains.

In the invention, it is preferable that a content of the alkyl naphthalene sulfonate is from 0.15 to 1.5% by weight of a total amount of the polishing composition.

In the invention, it is preferable that the polishing composition comprises an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid.

In the invention, it is preferable that the polishing composition comprises alkyl benzene sulfonic acid or its salt.

### BEST MODE FOR CARRYING OUT THE INVENTION

Now referring to the drawings, preferred embodiments of the invention are described below.

The polishing composition of the invention is a polishing composition suitable for a metal film, particularly a copper (Cu) film, and contains a basic compound containing an ammonium group, alkyl naphthalene sulfonate and hydrogen peroxide, the remainder being water. By containing those, a polishing composition that can achieve high polishing rate and improve flatness can be realized.

The polishing composition of the invention is described in detail below.

Examples of the basic compound containing an ammonium group contained in the polishing composition of the invention include ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate. Among them, ammonium hydroxide is preferred.

The content of the basic compound containing an ammonium group in the polishing composition of the invention is from 1 to 20% by weight, and preferably from 2 to 14% by weight, of the total amount of the polishing composition. Where the content of the basic compound containing an ammonium group is less than 1% by weight, sufficient polishing rate is not obtained. In the case where the content exceeds 20% by weight, pH control becomes difficult, or an organic acid dissolved precipitates. The polishing rate becomes nearly maximum when the content is 20% by weight, and even though the basic compound is added in an amount exceeding 20% by weight, improvement in polishing rate is not desired. For this reason, the upper limit is 20% by weight from the standpoint of costs.

The alkyl naphthalene sulfonate contained in the polishing composition of the invention includes dialkyl naphthalene sulfonic acid, and for example, butyl naphthalene sulfonic acid, nonyl naphthalene sulfonic acid, dinonyl naphthalene sulfonic acid and their salts (Na, Ca and K), and a mixture of alkyl naphthalene sulfonates having carbon number of from 1 to 14 in an alky group. Of those, the mixture of alkyl naphthalene sulfonates having carbon number of from 1 to 14 in an alky group is preferred.

As the salt, sodium salt, potassium salt, amine salt and the like are preferred, and sodium salt and amine salt are more preferred.

In an alkaline region, an ammonium group (NH₄⁺) acts as a complexing agent and an oxidizing agent to Cu, and reacts with Cu to form a complex as shown in the formula (1).

Cu+4NH₄⁺→[Cu(NH₃)₄)²⁺ (1)

In CMP of a copper film, it is considered that the tetraammine copper complex is removed by contacting with a polishing pad, and polishing proceeds.

Furthermore, when alkyl naphthalene sulfonate is present in a polishing composition, the alkyl naphthalene sulfonate coordinates so as to surround around the tetraammine copper complex, and a kind of a protective film is formed.

Etching of copper is suppressed by the protective film, and suppression of dishing or the like and improvement in level-difference elimination properties are realized. Furthermore, the protective film is difficult to be removed by polishing under low load, and suppresses polishing rate under low load. On the other hand, the protective film is easily removed when load is increased, and polishing acceleration effect by the tetraamine copper complex is exhibited.

Thus, by decreasing polishing rate in low load and increasing polishing rate in high load, load dependency is exhibited, level-difference elimination properties in a wiring part are improved, and flatness can be improved.

In particular, because static etching force is suppressed, dissolution of a copper film during non-polishing does not occur, and flatness can further be improved.

Furthermore, the content of the alkyl naphthalene sulfonate in the polishing composition of the invention varies its application range depending on whether to contain abrasive grains.

In the case that abrasive grains are not contained, the content of the alkyl naphthalene sulfonate is from 0.15 to 0.5% by weight, and more preferably from 0.2 to 0.5% by weight, of the total amount of the polishing composition. In the case that abrasive grains are contained, the content of the alkyl naphthalene sulfonate is from 0.15 to 1.5% by weight, and more preferably from 0.25 to 1.5% by weight, of the total amount of the polishing composition.

Where the content of the alkyl naphthalene sulfonate is less than the application range, static etching force is large and flatness is decreased. Where the content exceeds the application range, polishing rate under high load condition is decreased.

Furthermore, when the content of the alkyl naphthalene sulfonate is in a preferred range, polishing rate under low load is suppressed low, and polishing rate under high load can sufficiently be increased.

The invention can realize higher polishing rate by containing hydrogen peroxide.

The content of hydrogen peroxide in the polishing composition of the invention is from 0.1 to 5.0% by weight, and preferably from 0.5 to 4.0% by weight, of the total amount of the polishing composition. Where the content of hydrogen peroxide is less than 0.1% by weight, sufficient effect is not obtained, and where the content exceeds 5.0% by weight, oxidation reaction with cupper or the like is excessive, and control of polishing becomes difficult, which is not preferred.

In the polishing composition of the invention, as an oxidizing agent, other than hydrogen peroxide, for example, sulfuric acid, hydrochloric acid, nitric acid, iodic acid, iodate (such as potassium iodate), periodical acid, periodate (such as potassium periodate), persulfate, hypochlorous acid, ozone water and the like can be used. These oxidizing agents may be used each alone, or two or more of them may be used in combination.

The organic acid contained in the polishing composition of the invention is one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid. Among them, tartaric acid is preferred.

The content of the organic acid in the polishing composition of the invention is from 1.0 to 10% by weight, and preferably from 3.0 to 8.0% by weight, of the total amount of the polishing composition. Where the content of the organic acid is less than 1.0% by weight and exceeds 10% by weight, improvement in polishing rate is not almost seen.

The invention can suppress dishing by containing alkyl benzene sulfonic acid or its salt.

The content of the alkyl benzene sulfonic acid or its salt in the polishing composition of the invention is from 0.01 to 3.0% by weight, and preferably from 0.1 to 1.0% by weight, of the total amount of the polishing composition. Where the content of the alkyl benzene sulfonic acid or its salt is less than 0.01% by weight, sufficient effect of suppressing dishing is not obtained. Where the content exceeds 3.0% by weight, polishing rate under high load condition is decreased.

In the polishing composition of the invention, its pH may be within an alkaline pH range, preferably within a range of from 8 to 12, and more preferably within a range of from 9 to 10.5.

In the polishing composition of the invention, sufficient effect is exhibited even though abrasive grains are not contained. However, abrasive grains may be contained so long as the preferred characteristics of the invention are not impaired. Polishing rate can be improved by containing abrasive grains.

As the abrasive grains, materials conventionally used in this field can be used, and examples thereof include colloidal silica, fumed silica, colloidal alumina, fumed alumina and ceria.

The content of the abrasive grains in the polishing composition of the invention is from 0.01 to 7% by weight of the total amount of the polishing composition.

The polishing composition of the invention may further contains a pH regulator and the like in addition to the above components.

As to the pH regulator, examples of an acidic component include nitric acid (HNO₃), sulfuric acid, hydrochloric acid, acetic acid and lactic acid, and examples of an alkaline component include potassium hydroxide (KOH), calcium hydroxide and lithium hydroxide.

The polishing composition of the invention can contain one or two or more of various additives conventionally used in the polishing composition in this field so long as the preferred characteristics thereof are not impaired.

Water used in the polishing composition of the invention is not particularly limited. However, considering use in a production step of, for example, a semiconductor device, pure water, ultrapure water, ion-exchanged water, distilled water, and the like are preferred.

Method for producing the polishing composition of the invention is described below.

In the case where the polishing composition does not contain abrasive grains and consists of a basic compound containing an ammonium group, alkyl naphthalene sulfonate, hydrogen peroxide and other water-soluble additives, those compounds are used in appropriate amounts, and water is used in an amount to make the total amount 100% by weight. The polishing composition can be produced by uniformly dissolving or dispersing those components in water so as to have a desired pH according to the general procedures.

In the case that the polishing composition contains abrasive grains, alkyl naphthalene sulfonate is mixed with water, and only a given amount of an ammonia aqueous solution having a concentration of 30% is mixed therewith, thereby obtaining an alkali solution. A silica dispersion having a pH adjusted to 4.0 to 6.0 is mixed with the alkali solution so as to arrive at a given concentration. Only a given amount of hydrogen peroxide solution having a concentration of 30% was mixed with the alkali solution containing silica. Thus, a polishing composition of the invention is obtained.

The polishing composition of the invention can preferably be used in polishing of various metal films in LSI production process, and can, in particular, preferably used as a polishing slurry for polishing a metal film in CMP process in forming metal wiring by a damascene process. More specifically, the polishing composition of the invention can highly preferably be used as a metal film polishing slurry in forming, for example, metal wiring for stacking LSI chip in SIP, and upper layer copper wiring of semiconductor device (for the formation of the copper wiring, it is necessary to polish a copper film having a film thickness of 5 μm or more). In other words, the polishing composition of the invention is particularly useful as a metal film polishing composition for CMP process by a damascene process.

Examples of the metal film to be polished here include metal films such as copper and copper alloy to be coated on the surface of a substrate, tantalum, tantalum nitride, titanium, titanium nitride, and tungsten. Among them, a metal film of copper is particularly preferred.

The invention provides a polishing composition comprising:

a basic compound containing an ammonium group;

alkyl naphthalene sulfonate; and

hydrogen peroxide,

wherein the polishing composition has a pH of from 8 to 12, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate; and

hydrogen peroxide,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein the polishing composition has a pH of from 8 to 12.

The invention provides a polishing composition comprising:

a basic compound containing an ammonium group;

alkyl naphthalene sulfonate;

hydrogen peroxide; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

The invention provides a polishing composition comprising:

a basic compound containing an ammonium group;

alkyl naphthalene sulfonate;

hydrogen peroxide; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein the polishing composition has a pH of from 8 to 12, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide;

abrasive grains; and

an organic acid of one or two or more selected from among tartaric acid, citric acid, malic acid; ethylenediaminetetraacetic acid, oxalic acid, malonic acid, nicotinic acid, valeric acid, ascorbic acid, adipic acid, pyruvic acid, glycine, succinic acid and fumaric acid,

wherein the polishing composition has a pH of from 8 to 12.

The invention provides a polishing composition comprising:

a basic compound containing an ammonium group;

alkyl naphthalene sulfonate;

hydrogen peroxide;

abrasive grains; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein the polishing composition has a pH of from 8 to 12, and

a content of the alkyl naphthalene sulfonate is from 0.15 to 1.5% by weight of a total amount of the polishing composition.

The invention provides a polishing composition comprising:

a basic compound containing an ammonium group;

alkyl naphthalene sulfonate;

hydrogen peroxide;

abrasive grains; and

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 1.5% by weight of a total amount of the polishing composition.

The invention provides a polishing composition comprising:

a basic compound containing an ammonium group;

alkyl naphthalene sulfonate;

hydrogen peroxide; and

alkyl benzene sulfonic acid or its salt,

wherein the polishing composition has a pH of from 8 to 12.

The invention provides a polishing composition comprising:

a basic compound containing an ammonium group;

alkyl naphthalene sulfonate;

hydrogen peroxide; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

The invention provides a polishing composition comprising:

a basic compound containing an ammonium group;

alkyl naphthalene sulfonate;

hydrogen peroxide; and

alkyl benzene sulfonic acid or its salt,

wherein a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide; and

alkyl benzene sulfonic acid or its salt,

wherein the polishing composition has a pH of from 8 to 12, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide;

abrasive grains; and

alkyl benzene sulfonic acid or its salt,

wherein the polishing composition has a pH of from 8 to 12.

The invention provides a polishing composition comprising:

a basic compound containing an ammonium group;

alkyl naphthalene sulfonate;

hydrogen peroxide;

abrasive grains; and

alkyl benzene sulfonic acid or its salt,

wherein the polishing composition has a pH of from 8 to 12, and

a content of the alkyl naphthalene sulfonate is from 0.15 to 1.5% by weight of a total amount of the polishing composition.

The invention provides a polishing composition comprising:

a basic compound containing an ammonium group;

alkyl naphthalene sulfonate;

hydrogen peroxide;

abrasive grains; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 1.5% by weight of a total amount of the polishing composition.

The invention provides a polishing composition comprising:

a basic compound containing an ammonium group;

alkyl naphthalene sulfonate;

hydrogen peroxide;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt.

The invention provides a polishing composition comprising:

a basic compound containing an ammonium group;

alkyl naphthalene sulfonate;

hydrogen peroxide;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the polishing composition has a pH of from 8 to 12.

The invention provides a polishing composition comprising:

a basic compound containing an ammonium group;

alkyl naphthalene sulfonate;

hydrogen peroxide;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

The invention provides a polishing composition comprising:

a basic compound containing an ammonium group;

alkyl naphthalene sulfonate;

hydrogen peroxide;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the polishing composition has a pH of from 8 to 12, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 0.5% by weight of a total amount of the polishing composition.

The invention provides a polishing composition comprising:

a basic compound containing an ammonium group;

alkyl naphthalene sulfonate;

hydrogen peroxide;

abrasive grains;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt.

The invention provides a polishing composition comprising:

a basic compound containing an ammonium group;

alkyl naphthalene sulfonate;

hydrogen peroxide;

abrasive grains;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the polishing composition has a pH of from 8 to 12.

The invention provides a polishing composition comprising:

a basic compound containing an ammonium group;

alkyl naphthalene sulfonate;

hydrogen peroxide;

abrasive grains;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

The invention provides a polishing composition comprising:

a basic compound containing an ammonium group;

alkyl naphthalene sulfonate;

hydrogen peroxide;

abrasive grains;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein a content of the alkyl naphthalene sulfonate is from 0.15 to 1.5% by weight of a total amount of the polishing composition.

The invention provides a polishing composition comprising:

a basic compound containing an ammonium group;

alkyl naphthalene sulfonate;

hydrogen peroxide;

abrasive grains;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the polishing composition has a pH of from 8 to 12, and

a content of the alkyl naphthalene sulfonate is from 0.15 to 1.5% by weight of a total amount of the polishing composition.

The invention provides a polishing composition comprising:

a basic compound containing an ammonium group;

alkyl naphthalene sulfonate;

hydrogen peroxide;

abrasive grains;

an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid; and

alkyl benzene sulfonic acid or its salt,

wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate, and

a content of the alkyl naphthalene sulfonate is from 0.15 to 1.5% by weight of a total amount of the polishing composition.

### EXAMPLES

Examples and Comparative Examples of the invention are described below.

Examples and Comparative Examples of the invention were prepared with the following compositions, respectively.

(Example 1)

| | |
|---|---|
| Ammonia | 5% by weight |
| Tartaric acid | 5% by weight |
| Na C1-14 alkyl naphthalene sulfonate | 0.3% by weight |
| Hydrogen peroxide | 2% by weight |
| Water | Remainder |

(Example 2)

| | |
|---|---|
| Ammonia | 5% by weight |
| Na C1-14 alkyl naphthalene sulfonate | 1.0% by weight |
| Hydrogen peroxide | 2% by weight |
| Abrasive grains: Colloidal silica | 3% by weight |
| Water | Remainder |

(Comparative Example 1)

| | |
|---|---|
| Ammonia | 5% by weight |
| Tartaric acid | 5% by weight |
| Hydrogen peroxide | 2% by weight |
| Water | Remainder |

By adding an appropriate amount of a pH regulator (sulfuric acid) were adjusted pHs in the Examples and the Comparative Example to 10.3.

Comparative Example 1 has the same composition as that of Example 1 except that Na C1-14 alkyl naphthalene sulfonate is not contained. Example 2 is the composition that abrasive grains are added to Example 1 and tartaric acid as an organic acid is not contained.

The Na C1-14 alkyl naphthalene sulfonate is a mixture of Na alkyl naphthalene sulfonates having carbon number of from 1 to 14, and SOLBALIGHT BX-L manufactured by Kyoeisha Chemical Co., Ltd. was used in Example 1.

Using the above Examples 1 and 2, and Comparative Example 1, polishing rate was measured. Polishing conditions and evaluation method of polishing rate are shown below.

Polishing Conditions

Substrate to be polished: 100-mm diameter copper-plated substrate

Polishing apparatus: ECOMET 4 (manufactured by BUEHLER)

Polishing pad: MH pad (manufactured by Nitta Haas Incorporated)

Rotation rate of polishing platen: 100 rpm

Rotation rate of carrier: 65 rpm

Polishing load surface pressure: 5 hPa, 140 hPa

Flow rate of semiconductor polishing composition: 30 ml/min

Polishing time: 60 seconds

Polishing Rate

The polishing rate is represented by a thickness (μm/min) of a wafer removed by polishing per unit time. The thickness of a wafer removed by polishing was calculated by measuring weight loss of the weight of a wafer and dividing the weight loss by an area of polished surface of a wafer.

Load dependency was evaluated by polishing rate ratio between polishing rate under low load condition (5 hPa) and polishing rate under high load condition (140 hPa). The results are shown in Table 1.

TABLE 1

| | Load | Polishing rate | Polishing |
|---|---|---|---|
| | [hPa] | [μm/min] | rate ratio |
| Example 1 | 5 | 1.5 | 6.0 |
| | 140 | 9.0 | |
| Example 2 | 5 | 0.3 | 12.3 |
| | 140 | 3.7 | |
| Comparative | 5 | 8.7 | 1.5 |
| Example 1 | 140 | 13.3 | |

Comparative Example 1 does not contain Na alkyl naphthalene sulfonate. Therefore, polishing rate cannot be suppressed low under low load condition, and load dependency was not seen.

Regarding Examples 1 and 2 containing Na alkyl naphthalene sulfonate, load dependency was clearly seen.

### [Investigation on Content of Alkyl Naphthalene Sulfonate]

(Case that does not Contain Abrasive Grains)

Based on the composition of Example 1, polishing rates under low load (5 hPa) and high load (140 hPa) when the content of alkyl naphthalene sulfonate was changed from 0.1% by weight to 0.8% by weight were measured.

Evaluation methods of the polishing condition and the polishing rate are the same as above.

Furthermore, static etching rate was measured for the purpose of evaluation of etching force.

### Static Etching Rate

A copper printed substrate of 30 mm×30 mm was used as a sample, and the sample was dipped in a polishing composition in which the content of alkyl naphthalene sulfonate was changed, for a dipping time in solution of 60 seconds.

Decrease in thickness by static etching was calculated from a copper foil thickness before dipping in the polishing composition and a copper foil thickness after dipping therein.

Measurement results of polishing rates under low load (5 hPa) and high load (140 hPa), and static etching rate are shown in Table 2.

TABLE 2

| Content | Load | Polishing rate | Etching rate |
|---|---|---|---|
| [% by weight] | [hPa] | [μm/min] | [μm/min] |
| 0 | 5 | 8.7 | 6.1 |
| | 140 | 13.3 | |
| 0.10 | 5 | — | 3.4 |
| | 140 | — | |
| 0.15 | 5 | 2.1 | 1.0 |
| | 140 | 8.2 | |
| 0.20 | 5 | 1.5 | 0.7 |
| | 140 | 8.1 | |
| 0.25 | 5 | 1.1 | 0.2 |
| | 140 | 7.9 | |
| 0.30 | 5 | 1.5 | 0 |
| | 140 | 9.0 | |
| 0.50 | 5 | 0 | 0 |
| | 140 | 1.2 | |
| 0.65 | 5 | 0 | 0 |
| | 140 | 0.3 | |
| 0.80 | 5 | 0 | 0 |
| | 140 | 0 | |

From the above results, when the range satisfying that the static etching rate is suppressed to 3 μm/min or less and the polishing rate under high load is 1 μm/min or more is considered as the application range of the content of alkyl naphthalene sulfonate, the application range is from 0.15 to 0.5% by weight.

Furthermore, when the range satisfying that the static etching rate is suppressed to less than 1 μm/min and the polishing rate under high load is 1 μm/min or more is considered as the preferred application range of the content of alkyl naphthalene sulfonate, the application range is more preferably from 0.2 to 0.5% by weight.

(Case that Contains Abrasive Grains)

Based on the composition of Example 2, the polishing rates under low load (5 hPa) and high load (140 hPa) when the content of alkyl naphthalene sulfonate was changed from 0.1 to 3.0% by weight were measured.

Evaluation methods of the polishing condition and the polishing rate are the same as above.

To evaluate etching force, the static etching rate was measured in the same manner as above.

The measurement results of the polishing rates under low load (5 hPa) and high load (140 hPa) and the static etching rate are shown in Table 3.

TABLE 3

| Content | Load | Polishing rate | Etching rate |
|---|---|---|---|
| [% by weight] | [hPa] | [μm/min] | [μm/min] |
| 0 | 5 | 8.7 | 6.1 |
| | 140 | 13.3 | |
| 0.10 | 5 | — | 3.4 |
| | 140 | — | |
| 0.15 | 5 | 2.4 | 1.0 |
| | 140 | 8.2 | |
| 0.25 | 5 | 1.1 | 0.2 |
| | 140 | 7.9 | |
| 0.30 | 5 | 1.5 | 0 |
| | 140 | 8.2 | |
| 0.50 | 5 | 1.0 | 0 |
| | 140 | 7.0 | |
| 0.80 | 5 | 1.1 | 0 |
| | 140 | 6.7 | |
| 1.0 | 5 | 0.3 | 0 |
| | 140 | 3.7 | |
| 1.5 | 5 | 0 | 0 |
| | 140 | 1.9 | |
| 2.0 | 5 | 0 | 0 |
| | 140 | 0.7 | |
| 3.0 | 5 | 0 | 0 |
| | 140 | 0 | |

From the above results, when the range satisfying that the static etching rate is suppressed to 3 μm/min or less and the polishing rate under high load is 1 μm/min or more is considered as the application range of the content of alkyl naphthalene sulfonate, the application range is from 0.15 to 1.5% by weight.

Furthermore, when the range satisfying that the static etching rate is suppressed to 1 μm/min or less and the polishing rate under high load is 1 μm/min or more is considered as the preferred application range of the content of alkyl naphthalene sulfonate, the application range is more preferably from 0.25 to 1.5% by weight.

### [Investigation on Content of Abrasive Grains]

In the case of containing abrasive grains, load dependency tends to be decreased by the increase of polishing rate under low load. This tendency remarkably appears under the conditions that the content of alkyl naphthalene sulfonate is low and the effect of a protective film is weak. Therefore, in investigating the preferred range of the content of the abrasive grains, the preferred range is investigated at only the lower limit in the preferred range of the content of alkyl naphthalene sulfonate.

(Investigation Example)

| | | |
|---|---|---|
| Ammonia | 5% | by weight |
| Na C1-14 alkyl naphthalene sulfonate | 0.15% | by weight |
| Hydrogen peroxide | 2% | by weight |
| Abrasive grains: Colloidal silica | 1-10% | by weight |

| | |
|---|---|
| Water | Remainder |

Based on the composition of Investigation Example, the polishing rates under low load (5 hPa) and high load (140 hPa) when the content of abrasive grains was changed from 1 to 10% by weight were measured.

Evaluation methods of the polishing condition and the polishing rate are the same as above.

Load dependency was evaluated by polishing rate ratio between polishing rate under low load condition (5 hPa) and polishing rate under high load condition (140 hPa). The results are shown in Table 4.

TABLE 4

| Content | Load | Polishing rate | Polishing |
|---|---|---|---|
| [% by weight] | [hPa] | [μm/min] | rate ratio |
| 1 | 5 | 2.0 | 4.2 |
| | 140 | 8.3 | |
| 2 | 5 | 2.0 | 4.1 |
| | 140 | 8.1 | |
| 3 | 5 | 2.7 | 3.0 |
| | 140 | 8.2 | |
| 4 | 5 | 3.1 | 3.0 |
| | 140 | 9.4 | |
| 5 | 5 | 3.3 | 3.1 |
| | 140 | 10.1 | |
| 7 | 5 | 3.5 | 3.0 |
| | 140 | 10.5 | |
| 10 | 5 | 5.1 | 2.1 |
| | 140 | 10.9 | |

The polishing composition of the invention increases the polishing rate under both low load and high load by containing abrasive grains. However, rate of the increase under low load is large, and load dependency was decreased with increasing the content.

When the range satisfying the condition that can obtain the polishing rate ratio of 3 or more is considered as the application range of the content of abrasive grains, the application range is 7% by weight or less.

### [Investigation on Kind of Basic Compound]

Based on the composition of Example 1, polishing rates under low load (5 hPa) and high load (140 hPa) were measured by changing the kind of the basic compound.

### Example 3

Example 3 was obtained in the same manner as in Example 1, except for using ammonium chloride in place of ammonia (ammonium hydroxide) as the basic compound.

### Example 4

Example 4 was obtained in the same manner as in Example 1, except for using ammonium carbonate in place of ammonium hydroxide as the basic compound.

### Example 5

Example 5 was obtained in the same manner as in Example 1, except for using ammonium nitrate in place of ammonium hydroxide as the basic compound.

### Example 6

Example 6 was obtained in the same manner as in Example 1, except for using ammonium sulfate in place of ammonium hydroxide as the basic compound.

### Example 7

Example 7 was obtained in the same manner as in Example 1, except for using ammonium disulfate in place of ammonium hydroxide as the basic compound.

### Example 8

Example 8 was obtained in the same manner as in Example 1, except for using ammonium nitrite in place of ammonium hydroxide as the basic compound.

### Example 9

Example 9 was obtained in the same manner as in Example 1, except for using ammonium sulfite in place of ammonium hydroxide as the basic compound.

### Example 10

Example 10 was obtained in the same manner as in Example 1, except for using ammonium hydrogen carbonate in place of ammonium hydroxide as the basic compound.

### Example 11

Example 11 was obtained in the same manner as in Example 1, except for using ammonium acetate in place of ammonium hydroxide as the basic compound.

### Example 12

Example 12 was obtained in the same manner as in Example 1, except for using ammonium oxalate in place of ammonium hydroxide as the basic compound.

### Example 13

Example 13 was obtained in the same manner as in Example 1, except for using ammonium peroxoate in place of ammonium hydroxide as the basic compound.

### Example 14

Example 14 was obtained in the same manner as in Example 1, except for using ammonium phosphate in place of ammonium hydroxide as the basic compound.

### Example 15

Example 15 was obtained in the same manner as in Example 1, except for using ammonium pyrophosphate in place of ammonium hydroxide as the basic compound.

### Example 16

Example 16 was obtained in the same manner as in Example 1, except for using ammonium adipate in place of ammonium hydroxide as the basic compound.

By adding an appropriate amount of a pH regulator (potassium hydroxide or sulfuric acid) were adjusted pHs in Examples 3 to 16 to 10.

Evaluation methods of the polishing condition and polishing rate are the same as above.

Measurement results of the polishing rates under low load (5 hPa) and high load (140 hPa) are shown in Table 5.

TABLE 5

| | Load | Polishing rate | Etching rate |
|---|---|---|---|
| | [hPa] | [μm/min] | ratio |
| Example 3 | 5 | 0.6 | 6.0 |
| | 140 | 3.6 | |
| Example 4 | 5 | 0.6 | 5.2 |
| | 140 | 3.1 | |
| Example 5 | 5 | 0.9 | 4.0 |
| | 140 | 3.6 | |
| Example 6 | 5 | 0.7 | 4.7 |
| | 140 | 3.3 | |
| Example 7 | 5 | 0.5 | 5.2 |
| | 140 | 2.6 | |
| Example 8 | 5 | 0.4 | 6.0 |
| | 140 | 2.4 | |
| Example 9 | 5 | 0.5 | 4.6 |
| | 140 | 2.3 | |
| Example 10 | 5 | 0.5 | 5.4 |
| | 140 | 2.7 | |
| Example 11 | 5 | 0.4 | 7.8 |
| | 140 | 3.1 | |
| Example 12 | 5 | 0.5 | 6.4 |
| | 140 | 3.2 | |
| Example 13 | 5 | 0.6 | 4.0 |
| | 140 | 2.4 | |
| Example 14 | 5 | 0.4 | 8.5 |
| | 140 | 3.4 | |
| Example 15 | 5 | 0.4 | 7.3 |
| | 140 | 2.9 | |
| Example 16 | 5 | 0.4 | 6.0 |
| | 140 | 2.4 | |

Even in the case of using the above ammonium salt other than ammonium hydroxide as the basic acid, load dependency was clearly seen.

### [Investigation on Kind of Organic Acid]

Based on the composition of Example 1, polishing rates under low load (5 hPa) and high load (140 hPa) were measured by changing the kind of the organic acid.

### Example 17

Example 17 was obtained in the same manner as in Example 1, except for using citric acid in place of tartaric acid as the organic acid.

### Example 18

Example 18 was obtained in the same manner as in Example 1, except for using malic acid in place of tartaric acid as the organic acid.

### Example 19

Example 19 was obtained in the same manner as in Example 1, except for using ethylenediaminetetraacetic acid in place of tartaric acid as the organic acid.

### Example 20

Example 20 was obtained in the same manner as in Example 1, except for using oxalic acid in place of tartaric acid as the organic acid.

### Example 21

Example 21 was obtained in the same manner as in Example 1, except for using malonic acid in place of tartaric acid as the organic acid.

### Example 22

Example 22 was obtained in the same manner as in Example 1, except for using nicotinic acid in place of tartaric acid as the organic acid.

### Example 23

Example 23 was obtained in the same manner as in Example 1, except for using valeric acid in place of tartaric acid as the organic acid.

### Example 24

Example 24 was obtained in the same manner as in Example 1, except for using ascorbic acid in place of tartaric acid as the organic acid.

### Example 25

Example 25 was obtained in the same manner as in Example 1, except for using adipic acid in place of tartaric acid as the organic acid.

### Example 26

Example 26 was obtained in the same manner as in Example 1, except for using pyruvic acid in place of tartaric acid as the organic acid.

### Example 27

Example 27 was obtained in the same manner as in Example 1, except for using glycine in place of tartaric acid as the organic acid.

### Example 28

Example 28 was obtained in the same manner as in Example 1, except for using succinic acid in place of tartaric acid as the organic acid.

### Example 29

Example 29 was obtained in the same manner as in Example 1, except for using fumaric acid in place of tartaric acid as the organic acid.

By adding an appropriate amount of a pH regulator (potassium hydroxide or sulfuric acid) were adjusted pHs in Examples 17 to 29 to 10.

Evaluation methods of polishing conditions and polishing rates are the same as above.

Measurement results of the polishing rates under low load (5 hPa) and high load (140 hPa) are shown in Table 6.

TABLE 6

| | Load | Polishing rate | Etching rate |
|---|---|---|---|
| | [hPa] | [μm/min] | ratio |
| Example 17 | 5 | 1.6 | 5.4 |
| | 140 | 8.7 | |
| Example 18 | 5 | 1.4 | 6.2 |
| | 140 | 8.7 | |
| Example 19 | 5 | 1.6 | 5.4 |
| | 140 | 8.6 | |
| Example 20 | 5 | 1.4 | 6.0 |
| | 140 | 8.4 | |
| Example 21 | 5 | 0.9 | 9.2 |
| | 140 | 8.3 | |
| Example 22 | 5 | 1.6 | 5.1 |
| | 140 | 8.2 | |
| Example 23 | 5 | 1.6 | 5.5 |
| | 140 | 8.8 | |
| Example 24 | 5 | 1.6 | 4.6 |
| | 140 | 7.3 | |
| Example 25 | 5 | 1.4 | 5.4 |
| | 140 | 7.6 | |
| Example 26 | 5 | 1.5 | 4.9 |
| | 140 | 7.4 | |
| Example 27 | 5 | 0.5 | 18.6 |
| | 140 | 9.3 | |
| Example 28 | 5 | 0.6 | 14.5 |
| | 140 | 8.7 | |
| Example 29 | 5 | 0.5 | 16.8 |
| | 140 | 8.4 | |

Even in the case of using the above organic acids other than tartaric as the organic acid, load dependency was clearly seen.

### [Investigation on Content of Alkyl Benzene Sulfonate]

(Investigation Example)

| | | |
|---|---|---|
| Ammonia | 5% | by weight |
| Na C1-14 alkyl naphthalene sulfonate | 0.3% | by weight |
| Amine alkyl benzene sulfonate | 0.005-5% | by weight |
| Hydrogen peroxide | 2% | by weight |

| | |
|---|---|
| Water | Remainder |

Based on the composition of Investigation Example, the dishing amount and the polishing rates under low load (5 hPa) and high load (140 hPa) when the content of an amine alkyl benzene sulfonate was changed from 0.005 to 5% by weight.

The polishing conditions and the evaluation method of polishing rate are the same as above. Regarding the measurement of dishing amount, polishing load surface pressure is 140 hPa, and 100-mm diameter copper-plated substrate as a substrate to be polished is such that copper wiring having wiring width of 100 μm and depth of 5 μm is provided, and copper plating film having a thickness of 8 μm is formed on the whole surface thereof.

Dishing Amount

A 100-mm diameter copper-plated substrate as a substrate to be polished was polished, and time corresponding to 30% of the time required to expose copper wiring was used as additional polishing time. After confirming that the copper wiring was exposed, polishing was further conducted for only the additional polishing time. After completion of the additional polishing time, depth of recesses formed on the surface of the copper wiring is measured with a stylus profiler (trade name: P12, manufactured by KLA-Tencor Corporation), and the measurement result is used as dishing amount.

For the sake of comparison, the dishing amount was measured in Example 1 and Comparative Example 1.

Measurement results of the dishing amount and the load dependency are shown in Table 7. The load dependency was evaluated by polishing rate ratio between polishing rate under low load condition (5 hPa) and polishing rate under high load condition (140 hPa).

TABLE 7

| Content | Dishing amount | Load | Polishing rate | Polishing |
|---|---|---|---|---|
| [% by weight] | [μm] | [hPa] | [μm/min] | rate ratio |
| 0.005 | 1.25 | 5 | 1.5 | 6.0 |
| | | 140 | 9.0 | |
| 0.01 | 0.88 | 5 | 1.48 | 6.1 |
| | | 140 | 9.0 | |
| 0.1 | 0.51 | 5 | 1.3 | 6.8 |
| | | 140 | 8.8 | |
| 0.5 | 0.32 | 5 | 0.8 | 9.8 |
| | | 140 | 7.8 | |
| 1.0 | 0.25 | 5 | 0.35 | 21.4 |
| | | 140 | 7.5 | |
| 2.0 | 0.21 | 5 | 0.3 | 13.0 |
| | | 140 | 3.9 | |
| 3.0 | 0.21 | 5 | 0.27 | 11.9 |
| | | 140 | 3.2 | |
| 5.0 | 0.23 | 5 | 0.27 | 5.6 |
| | | 140 | 1.5 | |
| 0 | 1.32 | 5 | 1.5 | 6.0 |
| (Example 1) | | 140 | 9.0 | |
| 0 | 4.5 | 5 | 8.7 | 1.5 |
| (Comparative | | 140 | 13.3 | |
| Example 1) | | | | |

When the content of alkyl benzene sulfonate was increased, the dishing amount was suppressed, and additionally, the polishing rate under low load condition was suppressed, and load dependency was improved. The effect of suppressing dishing amount is sufficiently exhibited when the content is 0.01% by weight or more, and when the content exceeds 1% by weight, the effect was nearly constant. When the content is 5.0% by weight which exceeds 3.0% by weight, the polishing rate under high load condition is decreased, and the polishing rate when the content is 3% by weight is about ⅓ of the polishing rate under high load condition of Example 1 that does not contain alkyl benzene sulfonate, whereas the polishing rate when the content is 5.0% by weight is decreased to about ⅙ of the polishing rate under high load condition of Example 1.

From the above fact, the content of alkyl benzene sulfonate is preferably from 0.01 to 3.0% by weight of the total amount of the polishing composition.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, there is provided a polishing composition comprising a basic compound containing an ammonium group, alkyl naphthalene sulfonate, and hydrogen peroxide.

Polishing rate under low load is low, polishing rate under high load is high, level-difference elimination properties in wiring part is excellent as a ratio of the respective polishing rates is increased, that is, as load dependency is increased, and flatness is improved.

In the invention, by making the composition as above, not only high polishing rate is achieved, but load dependency can be increased, thereby flatness can be improved. Furthermore, flatness can further be improved by decreasing etching force.

According to the invention, it is preferable that the polishing composition has a pH of from 8 to 12, and is used in an alkaline state. In the case of the polishing composition having a pH smaller than 8, polishing rate is decreased, and in the case of the polishing composition having a pH exceeding 12, etching rate of copper is increased and flatness is deteriorated.

According to the invention, as the basic compound containing an ammonium group, one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

According to the invention, the content of alkyl naphthalene sulfonate is from 0.15 to 0.5% by weight of the total amount of the polishing composition. Where the content is smaller than 0.15% by weight, etching force cannot sufficiently be suppressed, and where the content is larger than 0.5% by weight, polishing rate under high load is decreased.

According to the invention, polishing rate can further be improved by containing abrasive grains.

According to the invention, the content of alkyl naphthalene sulfonate is from 0.15 to 1.5% by weight of the total amount of the polishing composition. Where the content is smaller than 0.15% by weight, etching force cannot sufficiently be suppressed, and where the content is larger than 1.5% by weight, polishing rate under high load is decreased.

According to the invention, further improvement can be achieved by containing an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid.

According to the invention, dishing can be suppressed by containing alkyl benzene sulfonate or its salt.

1. A polishing composition comprising a basic compound containing an ammonium group, alkyl naphthalene sulfonate and hydrogen peroxide.

2. The polishing composition of claim 1, wherein the polishing composition has a pH of from 8 to 12.

3. The polishing composition of claim 1, wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

4. The polishing composition of claim 1, wherein a content of the alkyl naphthalene sulfonate is from 0.15 to 0.5% by weight of a total amount of the polishing composition.

5. The polishing composition of claim 1, comprising abrasive grains.

6. The polishing composition of claim 5, wherein a content of the alkyl naphthalene sulfonate is from 0.15 to 1.5% by weight of a total amount of the polishing composition.

7. The polishing composition of claim 1, comprising an organic acid of one or two or more selected from among tartaric acid, citric acid, malic acid, ethylenediaminetetraacetic acid, oxalic acid, malonic acid, nicotinic acid, valeric acid, ascorbic acid, adipic acid, pyruvic acid, glycine, succinic acid and fumaric acid.

8. The polishing composition of claim 1, comprising alkyl benzene sulfonic acid or its salt.

9. The polishing composition of claim 2, comprising abrasive grains.

10. The polishing composition of claim 3, comprising abrasive grains.

11. The polishing composition of claim 7, comprising abrasive grains.

12. The polishing composition of claim 8, comprising abrasive grains.

13. The polishing composition of claim 9, wherein a content of the alkyl naphthalene sulfonate is from 0.15 to 1.5% by weight of a total amount of the polishing composition.

14. The polishing composition of claim 10, wherein a content of the alkyl naphthalene sulfonate is from 0.15 to 1.5% by weight of a total amount of the polishing composition.

15. The polishing composition of claim 11, wherein a content of the alkyl naphthalene sulfonate is from 0.15 to 1.5% by weight of a total amount of the polishing composition.

16. The polishing composition of claim 12, wherein a content of the alkyl naphthalene sulfonate is from 0.15 to 1.5% by weight of a total amount of the polishing composition.

17. The polishing composition of claim 9, wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

18. The polishing composition of claim 11, wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.

19. The polishing composition of claim 12, wherein the basic compound containing an ammonium group is one or two or more selected from among ammonium hydroxide, ammonium chloride, ammonium carbonate, ammonium nitrate, ammonium sulfate, ammonium disulfate, ammonium nitrite, ammonium sulfite, ammonium hydrogen carbonate, ammonium acetate, ammonium oxalate, ammonium peroxoate, ammonium phosphate, ammonium pyrophosphate and ammonium adipate.
